(19) United States
(12) Patent Application Publication
(10) Pub. No.: US 2007/0209000 A1
(43) Pub. Date: Sep. 6, 2007

(54) CALENDAR-TYPE MEDIA DEVICE

(76) Inventors: Philippe M. Moisan, Hong Kong Sar (HK); Richard J. Collini, Hong Kong Sar (HK)

Correspondence Address: PHILIPPE M. MOISAN, RM 1502, TUNG WAH MANSION, 203 HENNESSY RD., WANCHAI, HONG KONG SAR, HK

(21) Appl. No.: 11/623,100

(22) Filed: Jan. 15, 2007

(30) Foreign Application Priority Data
Jan. 16, 2006 (DE) EP06100413.1

(51) Int. Cl. G06F 3/00; G09G 3/00

(52) U.S. Cl. 715/700; 345/30

(57) ABSTRACT

The present invention relates to a calendar-type device, such as an advent calendar, comprising a housing (11) having a user interface, said user interface comprising at least one actuable element (19), said at least one element representing a plurality of distinct events, means (29,30) for providing a plurality of distinct media content, at least one output means (22,23) for reproducing said media content, at least one micro-controller (30), and at least one source of electrical energy (34), wherein said at least one actuable element (19), said means for providing media content (29,30), said means for reproducing said media content (22,23) and said source of electrical energy (34) are electrically connected to said micro-controller (30), said micro-controller being adapted to identify the actuation of said at least one actuable elements (19), to associate a specific media content with said actuated element (19) and to control the output of said media content via said output means.

The present invention relates to a calendar-type media device comprising a housing having a user interface that comprises a plurality of actuable elements, each actuable element representing a distinct event, and means for providing media content such as sound, light, text or combinations thereof.

Calendar-type devices of the above-mentioned type are known in the art. In a popular embodiment, such devices are known as “advent calendars”, which usually comprise shallow containers or trays comprising a multiplicity of compartments or grooves for confectionery or candy, each compartment being closed by a small flap or door which can be opened by the user to access the confectionery housed in the compartment. Usually, advent calendars have 24 or 25 compartments corresponding to the days from December 1^{st} to Christmas Eve (December 24^{th}) or Christmas Day (December 25^{th}), respectively. Instead of confectionery, these compartments may also house other three-dimensional objects such as toys. In other embodiments of advent calendars, there are no compartments at all and each flap covers a particular image typically associated with Christmas.

While the advent calendar is the most popular embodiment of such calendar-type devices, other embodiments may be associated with events such as birthdays, wedding days etc. Such calendar-type devices may also be associated with specific time periods such as holidays, football or motor sports seasons and the like. As a matter of course, the time increments between each distinct event do not necessarily have to correspond to days as in the case of an advent calendar, but may also be associated with weeks or months or, in sports-related calendars, with specific predetermined competition days. As another example, the calendar may also be associated with a pregnancy period. Further, the calendar-type device does not necessarily have to be associated with events in time at all. Rather, each actuable element may, for example, also be associated with specific persons, members of a sports team, e.g. a football team or various teams taking part in an international championship, etc. The calendar-type device may also be related to a specific theme such as, e.g. historical, geographical or scientific issues.

As a matter of course, the form factor of the calendar-type device may be adapted to a specific theme, e.g. when geographical issues are addressed, the device does not necessarily have to be made in a tabular form but may, for example, be made in the form of a globe.

Suggestions have been made to improve this kind of calendar device by adding sound or music. For example, U.S. Pat. No. 4,222,188 describes a combined merchandise display, sound reproducing device and insignia supporting unit which comprises a calendar-type device and a sound generator housed within the device. EP-A-0 253 003 describes a calendar-type wall calendar for confectionery which houses a musical device in its interior.

However, these known calendar-type devices suffer from the drawback that only a single sound or musical theme is associated with the device so that these devices tend to become stale when used over a prolonged period of time.

It is therefore the object of the present invention to provide a calendar-type device of the above-referenced type which offers a greater variety of interesting and more appealing features to the user and which can nonetheless be manufactured cost-effectively.

This object is achieved by providing a calendar-type device as defined in present claim 1. Preferred embodiments of the present invention are subject to the dependent claims.

Consequently, the present invention relates to a calendar-type device comprising: a housing having a user interface, said user interface comprising at least one actuable element, said at least one actuable element representing a plurality of distinct events; means for providing a plurality of distinct media content; at least one output means for reproducing said media content; at least one micro-controller; and at least one source of electrical energy; wherein said at least one actuable element, said means for providing media content, said means for reproducing said media content and said source of electrical energy are electrically connected to said micro-controller, said micro-controller being adapted to identify the actuation of any one of said distinct actuable elements, to associate a specific media content with said actuated element and to control the output of said media content via said output means. According to the invention, a single actuable element which is temporally associated with different distinct events may be provided. Preferably, however, the device of the present invention comprises a plurality of actuable elements, each actuable element representing a distinct event.

Accordingly, each distinct event represented by an actuable element is associated with a specific media content which may, for example, be a sound such as a musical recording; light, for example, flashing lights; or other media content including videos or, for example, text messages and combinations thereof. For example, in an advent calendar, the distinct events may be associated to different Christmas carols and the light effects may represent candles, decorated Christmas trees, lighted houses, etc., while in a geographical calendar, the musical themes may for instance be national anthems and the lights may highlight the borders or capitals of the respective countries or may show the flags of these countries. It has to be noted, however, that in the present invention, the term “media content” shall comprise not only acoustical or visual effects but may relate to any human sense. Thus, the calendar-type device of the invention may also release olfactory information, e.g. fragrances comprised in scratchable layers associated with said distinct events.

The micro-controller implemented in the calendar-type device of the present invention enables the implementation of a variety of features associated with each distinct event, thus enhancing the attractiveness and desirability of such devices considerably. As the micro-controller is a programmable device, one and the same assembly of the calendar-type device of the invention may easily be adapted to differently configured multi-media calendars, thus further reducing production costs in the long run.

A variety of actuable elements known in the art may be implemented in the calendar-type media device of the present invention, including movement sensors such as infrared sensors for detecting e.g. the approach of a user's finger. Preferably, however, the actuable elements comprise electrical switches which are responsive to an action of the user. Those switches may, for example, consist of electrical press buttons which are actuated directly by the user.

Advantageously, the actuable elements comprise moveable doors or flaps which are preferably pivotally arranged on the surface of the housing of the calendar-type device. According to one embodiment, opening these doors or flaps may provide access to the actuable elements arranged behind each door. According to another embodiment, these doors or flaps may be directly connected to the electrical switches in such a way that opening a door will directly actuate the respective switch. In order to facilitate opening of the doors or flaps, they many comprise a hinge side and a press area arranged at the opposite side of said hinge side. According to a preferred embodiment, the press area comprises two converging slit. Under the press area, a recess or opening may be foreseen which allows the press area to be depressed below the upper face of the calendar so that the user can grip the opposite side of the hinge side of the flap with a finger nail or finger tip in order to turn the flap upwards around it's hinge side.

In a stand-alone embodiment of the present invention, the means for providing media content comprise a storage means arranged within said housing. Depending on the amount of media content stored in the device of the present invention, the storage means may be part of the on-board storage of the micro-controller. For storing larger media data, additional storage means such as semiconductor-based storage means, for example, a flash memory, or small hard discs such as microdrives may be employed.

According to a further embodiment of the present invention, the calendar-type device is provided with means for receiving remote media content, for example, via wired or wireless LAN or via a Bluetooth-, a Firewire- or a USB-interface. In this embodiment, different media content representing distinct events can be provided in real time.

Consequently, a single actuable element may be provided on the calendar-type device of the present invention which is adapted to represent different distinct events temporally while media content associated with each of said distinct events is provided and controlled by the remote host.

The means for providing and/or storing media content and the micro-controller are implemented in a programmable integrated circuit which preferably includes a sound processor such as a music synthesizer.

The output means comprises at least one loudspeaker and/or at least one display such as a liquid crystal display, a light-emitting diode (LED) display or an organic light-emitting diode (OLED) display. Such a display may be employed to show videos, images, text such as lyrics of a concurrently played song, and the like. The device of the present invention may also comprise at least one light source which is controlled by said micro-controller. Preferably, the light source is synchronized with a concurrently reproduced audio content. According to a preferred embodiment, the at least one light source comprises a light-emitting diode arranged in the housing and a plurality of light-guiding fibres, each having one of their ends arranged in proximity to said light-emitting diode and the other end terminating in the surface of said housing.

In another embodiment of the invention, the display unit will also provide the actuable elements of the device. To this end, a so-called touch-screen display can be used which is configured by suitable software such that certain areas of the display correspond to certain distinct events. This embodiment of the calendar-type device of the invention would easily be adaptable to a large variety of themes, visual and sound effects by merely changing the software stored in the device.

According to another preferred embodiment of the present invention, the housing is made of printed cardboard folded and glued or otherwise bonded into a box-like shape. Preferably, a solid insert made from a lightweight but sufficiently rigid plastic material, such as polystyrene, is snugly fit into the housing. The solid insert is provided with recesses or depressions for housing the electrical components of the device of the invention such as micro-controllers, an energy source, output means and storage means. Accordingly, the electrical arrangement of the media-device is well protected, especially during shipping and rough usage. As a matter of course, instead of a box-like shape, the housing may have any particular shape desired. For instance, the shape may refer to a particular theme or event of the calendar, e.g. an advent calendar may have an outer contour of a Christmas tree, a wreath, a bell, etc.

The device of the present invention may be implemented in the same manner as any kind of theme calendar, such as those mentioned above, in which distinct events are associated with a set of particular features of a given theme. Preferably, however, the distinct events represented by said actuable elements are certain distinct dates, e.g. as in an advent calendar, the days from December ₁st to Christmas Eve or Christmas Day.

The present invention will now be described in more detail with respect to an advent calendar as a particular embodiment of the invention. This embodiment is depicted on the attached drawings.

### IN THESE DRAWINGS

FIG. 1 shows a schematic perspective view of an advent calendar of the present invention;

FIG. 2 shows a plan view of the box-shaped insert of the calendar of FIG. 1;

FIG. 3 shows a cross-section view of a press-button of the calendar of FIG. 1;

FIG. 4 shows a paper card with openings, which can be arranged on the upper side of the box-shaped insert of FIG. 2;

FIG. 5 shows a preferred profile of the flaps of the advent calendar; and

FIG. 6 shows an underside view of an opening of the paper card of FIG. 4.

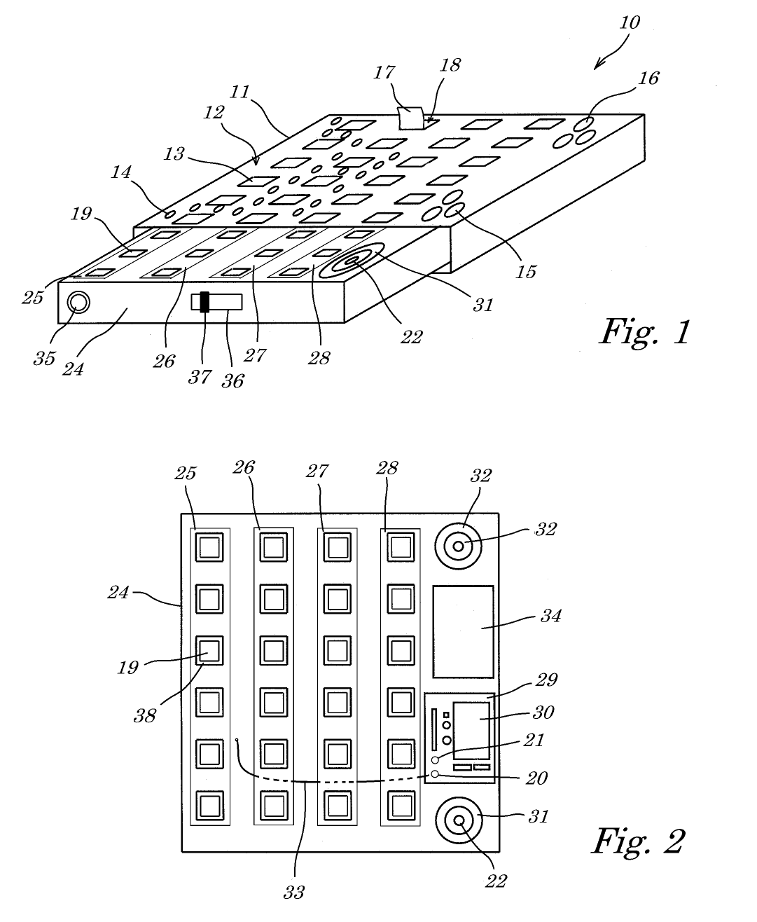

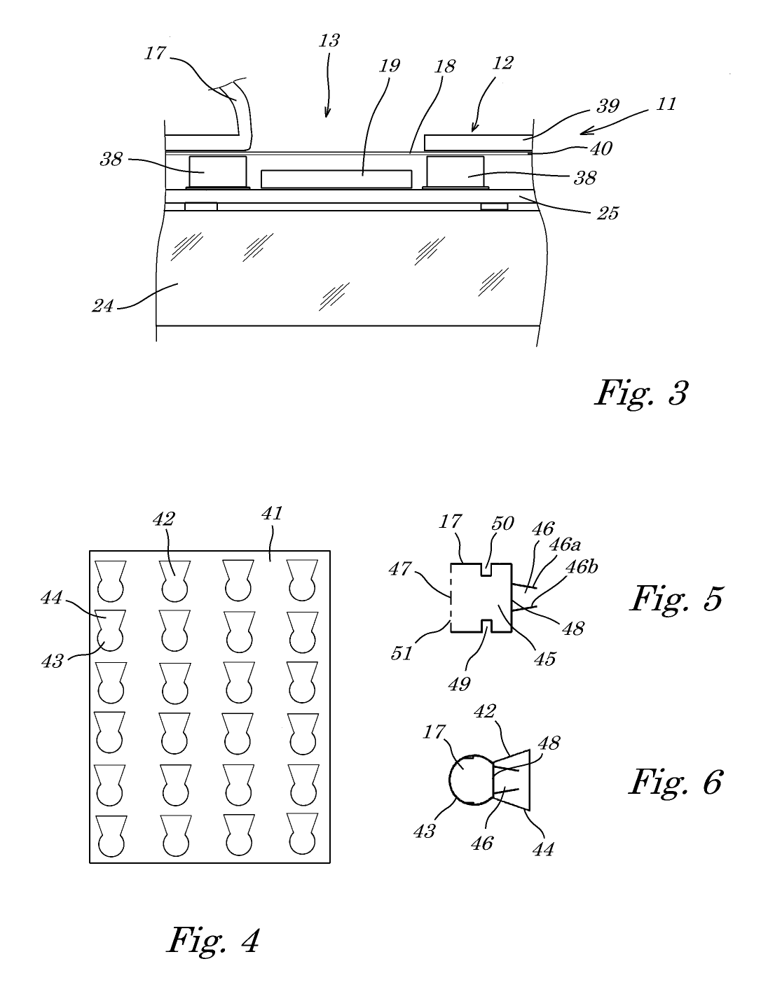

FIG. 1 depicts advent calendar 10 which comprises a housing 11 made from printed cardboard material and arranged in the form of a rectangular container. On the upper surface 12 of housing 11, twenty-four rectangular openings 13, corresponding to the days from December ₁st to Christmas Eve, and a multiplicity of small circular openings 14 are provided. Additional circular openings 15 and 16 with a larger diameter are provided in the lower corners of the upper surface 12. Each rectangular opening 13 is closed by a door or flap 17 pivotally arranged at one corner of opening 13 (for the sake of clarity, only one flap 17 is depicted in FIG. 1). Each opening 13 is provided with a closed bottom 18 on which individual images relating to e.g. Christmas themes may be printed. Underneath the printed bottom layer 18, user-actuable press buttons 19,which will be described with reference to FIG. 3 in more detail below, are arranged. The smaller circular openings 14 are arranged in correspondence to light-emitting surfaces of one or more light sources 20 and 21 (c.f. FIG. 2), which are arranged in housing 11 to enable the display of visual effects on the upper surface 12 of calendar 11. The larger circular openings 15 and 16 are arranged in correspondence to loudspeakers 22 and 23 arranged underneath said openings 15 and 16 to enable the emission of sound and music from calendar 10.

In the embodiment of FIG. 1, a polystyrene cube-shaped box 24 that fits snugly into housing 11 is shown partially extracted from the housing 11. As can be more clearly seen in the plan view FIG. 2, the polystyrene box 24 bears four printed circuit board (PCB) strips 25, 26, 27 and 28. On each PCB-strip six press buttons 19 are arranged to make up an array of twenty-four press buttons corresponding to the aforementioned twenty-four rectangular openings 13 when box 24 is arranged in housing 11.

Insertable box 24 further houses an electronic circuit 29 which includes one or more integrated circuits (ICs) comprising a micro-controller 30 and means for storing audio and/or video data and for generating audio and/or video signals from said stored data using, for example, a music synthesizer module. In the embodiment depicted in FIGS. 1-3, the generated audio signals are transferred to loudspeakers 22 and 23, which generate the corresponding sound or music. Each of loudspeakers 22 and 23 is preferably surrounded by a layer of a flexible cellular material 31 and 32, which acoustically decouples loudspeakers 22 and 23 from polystyrene box 24, thus improving the sound quality of the advent calendar.

Micro-controller 30 further controls light sources 20 and 21 by switching the light sources on and off in accordance with a programmed sequence. In the preferred embodiment depicted in the drawings, fibre optical light guides 33 are arranged on the surface of polystyrene box 24 with one end of each light guide terminating at one of the light sources and the other end terminating at one of the openings 14 arranged in surface 12 of housing 11 (when box 24 is arranged in said housing). For reasons of clarity, however, only one of said fibre optical light guides 33 is shown in FIG. 2. Consequently, each light source 20, 21 enables the illumination of one sub-set of openings 14. Depending on the desired visual effects, a large number of illuminated openings 14 may be provided. Typically, between 10 and 100 illuminated openings are provided in an advent calendar. Preferably, light sources 20 and 21 consist of light-emitting diodes (LEDs) of different colours, e.g. of red, green, yellow and/or blue LEDs. More than one LED of a given colour may be provided, thus enabling the illumination of the different sub-sets of openings 14 at different times with the same colour. Micro-controller 30 may also enable the control of the LEDs in accordance with beat and/or pitch of a concurrently replayed musical piece.

Polystyrene box 24 further houses a source of electrical energy, typically one or more batteries 34. Batteries 34 may be rechargeable or non-rechargeable, as well as replaceable or non-replaceable. Preferably, replaceable AAA or AA batteries are used.

Accordingly, the device of the present invention enables the reproduction of a wide range of intricate visual and sound patterns. As a matter of course, instead of using a limited number of LEDs whose light is guided via optical fibres to a multiplicity of openings 14, a one- or, preferably, two-dimensional array of LEDs arranged on the surface of polystyrene box 24 in correspondence with the openings 14 may also be employed to generate the desired visual patterns.

As shown in FIG. 1, the calendar may be provided with a test button 35 which allows the user to evaluate the calendar in a store before purchasing it. Therefore, test button 35 is accessible without opening the packing or even opening a flap. In a preferred embodiment, actuation of test button 35 will cause excerpts of several songs to be played. In addition, some visual effects might be displayed.

As can also be taken from FIG. 1, an ON/OFF switch 36 may be foreseen. Switch 36 may, e.g. by means of a slider 37, assume at least two different conditions. In the OFF condition, only test button 36 is active while buttons 19 on the upper side of box 24 are disabled thus avoiding a risk of unintended playback during transportation and handling. In the ON condition, button 35 is disabled, but the product's main function, i.e. the twenty four switches 19 are active. Consequently, media effects will only be displayed upon opening a flap and actuating the respective button. Thus, disabling test switch 36 in the ON condition avoids the user to become detracted by the test functionality during regular use of the advent calendar. As a matter of course, in another embodiment, one may also provide a switch which can assume three different conditions, namely ON/OFF/TEST, where all buttons are disabled in the OFF condition and only test button 36 is active in the TEST condition. In the embodiment of FIG. 1, ON/OFF switch 36 is located on a side wall of the calendar. As a matter of course, any other location, e.g. on the rear face in close proximity to a battery casing or integrated within a battery casing, is also possible.

According to a preferred embodiment of the invention, the advent calendar is constructed in such a manner that actuation of a given press button 19 is prevented when the corresponding flap 17 is closed. A first preferred arrangement of press buttons 19 which prevents an unintentional actuation of buttons 19 is depicted in FIG. 3. FIG. 3 shows a cross-sectional view of a press button 19 which is arranged on PCB-strip 25, which in turn is supported on the surface of polystyrene box 24. Each press button 19 is surrounded by a ring 38 made from a relatively rigid cardboard material which is thicker than the press button itself (e.g. cardboard ring 38 may have a typical thickness of 2.0 mm while press button 19 has a height between 1 and 1.5 mm). Ring 38 and press button 19 are bonded to the PCB-strip 25. As indicated in FIG. 3, press button 19 is recessed in housing 11, which, according to the embodiment of FIG. 3, is made from a two-layer structure comprising an outer layer 39 and an inner layer 40. The relatively rigid outer layer 39 forms the upper surface 12 of housing 11. The outer layer 39 further comprises the cut-out openings 13 and pivotally arranged flaps 17 for closing the openings 13. The pliable inner layer 40 forms the bottom 18 of opening 13 and is accessible to the user once flap 17 is in an open position as depicted in FIG. 3. In the depicted open position, the user can depress the pliable inner layer 40 in order to actuate press button 19. When flap 17 is closed, however, housing 11 is rigid enough to prevent a depression of the two-layer housing structure so that press button 19 cannot be actuated under usual handling conditions.

Playback of music and light effects can be initiated and stopped by actuating the appropriate press button associated with a distinct day. There may also be an additional press button (not depicted in the figures) to stop media reproduction. Further, the device may also comprise a master switch to turn the power source on and off.

FIG. 4 depicts a second preferred arrangement which prevents an unintentional actuation of the buttons 19 of the polystyrene box 24 of FIGS. 1 and 2. According to the second embodiment, the cardboard rings 35 are essentially replaced by a single paper card 41. Paper card 41, which is provided with twenty-four openings 42 matching the twenty-four press buttons 19, is arranged fixed on the upper side of polystyrene box 24. As will be described in more detail below, these openings 42 are configured to facilitate the opening of the flaps or doors 17 and to allow access to the respective press button 19 after opening the corresponding flap.

Most commercially available calendar surfaces are flexible. In order to open a flap, those calendars rely on two handed operation intended to flex the entire calendar surface in order to cause a partial surface of one or more flaps to protrude allowing the user to anchor a finger or at least a fingernail. This not very user-friendly concept is no longer applicable with the calendar of the present invention, where housing 11 is essentially rigid due to both the thickness of material employed for forming the housing and the polystyrene box-shaped insert 24. Thus, a further objective of the present invention is to create a user friendly mechanism for opening flaps 17 which is simple, intuitive and effective.

According to the present invention, each opening 42 is comprised by a circular section 43, essentially corresponding to the location of the associated press button 19, and a trunconical section 44, which corresponds to a press section of the associated overlying flap 17.

A preferred profile of the flaps 17 arranged in housing 11 (or in a two layer embodiment of housing 11: in the outer layer 39 of housing 11) is depicted in FIG. 5. In addition to a main section 45, which may have a circular or, as in the embodiment of FIG. 5, an essentially rectangular form, a press area 46 is foreseen along the outside of the flap edge directly opposite the flap hinge 47. The press area 46 is delimited by two converging slits 46a, 46b. In a two layer embodiment of housing 11, similar slits may be arranged in the inner layer 40 (c.f. FIG. 3) in correspondence with slits 46a, 46b arranged in the outer layer 39.

As can be seen in FIG. 6, showing an underside view of an opening 42 in paper card 41 and parts of an overlying flap 17, press area 46 of flap 17 is arranged above the trunconical section 44 of opening 42. Accordingly, when the user presses on this area 46, the slits 46a, 46b create structural lines along which the housing surface flexes and surrenders to the downward force. As the main section 45 of flap 11 does not move, its edge 48 directly adjacent to the press area 46 is exposed. The dimensions of the converging slits 46a, 46b in housing 11 and of the corresponding opening 42 in paper card 41, as well as the thickness of paper card 41 and the weight and properties of the housing 11 are all configured so that the exposed edge 48 is large enough to accommodate a fingernail or fingertip of the user. Afterwards, the user only has to lift and rotate the entire flap.

While conventional advent calendars are single-use disposable items, it is a further object of the present invention to provide an advent calendar that can be re-used. Accordingly, in a preferred embodiment of the present invention, means are provided which to ensure that after initial opening, the flaps 17 of the calendar can reliably be closed again and remain closed thereafter. According to the embodiment of FIG. 5, those means comprise two recesses 49, 50 arranged in the contour of the main section 45 of each flap 17. Thus recesses 49, 50 correspond to complementary locking taps in housing 11 which created additional areas of resistance which allow flap 11 to resume its original position, even after being opened several times.

Conventional advent calendars are provided with a dense perforation along the hinge side of each flap to allow the flaps to be rotated more easily and to be torn away afterwards, consistently with the one-advent season use for those calendars. Due to our more rigid and dense grade of material which is preferably used for housing 11 of the calendar of the present invention, the present invention suggests a new configuration of perforations 51 provided on the hinge side 47 of each flap 11. This new configuration allows for both an improved relieve of stress associated with the flap rotation in the housing area adjacent to the hinge 47 and to the flap surface itself, and for an optimised pivotal manipulation of the flaps. This improves stability and longevity of the flaps and its hinges thus further fostering reusability of the advent calendar of the invention. According to one embodiment, the configuration of the perforations 51 on the hinge side 47 is an alternate series of broken and unbroken sections, each section having a length in the range of 2 to 6 mm, preferably of approximately 4 mm. At each end of hinge side 47, an unbroken sections having a length in the range of 4 to 8 mm, preferably 6 mm is foreseen.

For mounting the calendar on a wall, a preferred embodiment not depicted in the drawings foresees that one or more, preferably two flap-like means with mounting holes are provided on the back side of housing 11. The user can fold the flap-like means backward, thus allowing a string to be threaded through the mounting hole in each flap thus allowing the calendar to be fixed to a wall nail.

1. A calendar-type device comprising
a housing (11) having a user interface, said user interface comprising at least one actuable element (19), said at least one element representing a plurality of distinct events,
means (29,30) for providing a plurality of distinct media content,
at least one output means (22,23) for reproducing said media content,
at least one micro-controller (30), and
at least one source of electrical energy (34),
wherein said at least one actuable element (19), said means for providing media content (29,30), said means for reproducing said media content (22,23) and said source of electrical energy (34) are electrically connected to said micro-controller (30),
said micro-controller being adapted to identify the actuation of said at least one actuable elements (19), to associate a specific media content with said actuated element (19) and to control the output of said media content via said output means.

2. The device of claim 1, wherein a plurality of actuable elements (19) are provided, each element representing a distinct event.

3. The device of one of claims 1 or 2, wherein said actuable elements (19) comprise electrical switches which are responsive to user actuation.

4. The device of claim 3, wherein said actuable elements (19) comprise doors or flaps (17) which are movably arranged on said housing (11).

5. The device of claim 4, wherein a switch is associated with each door, said electrical switches being responsive to a movement of said doors or flaps (17).

6. The device of one of claims 3 or 4, wherein said electrical switches comprise press buttons.

7. The device of one of claims 4 to 6, wherein said doors or flaps (17) comprise a hinge side (47) and a press area (46) arranged at the opposite side (48) of said hinge side.

8. The device of claim 7, wherein said press area (46) comprises two converging slits (46a, 46b).

9. The device of one of claims 1 to 8, wherein the means for providing media content comprises a storage means arranged in said housing.

10. The device of one of claims 1 to 9, wherein said media content comprises audio data or video data or a combination thereof.

11. The device of one of claims 1 to 10, further comprising at least one light source (20,21), said light source being controlled by said micro-controller (30).

12. The device of claim 11, wherein said at least one light source (20,21) comprises a light-emitting diode arranged in said housing (11) and a plurality of light-guiding fibres (33), each having one of their ends arranged in proximity to said light-emitting diode and the other end terminating near the surface (12) of said housing.

13. The device of one of claims 1 to 12, wherein said means for providing and/or storing media content and said micro-controller are implemented in a programmable integrated circuit component, preferably in a sound processor.

14. The device of one of claims 1 to 13, wherein said output means comprises at least one loudspeaker (22,23) and/or at least one display.

15. The device of one of claims 1 to 14, wherein said distinct events represented by said actuable elements are distinct dates.

16. The device of one of claims 1 to 15, wherein said means for providing a plurality of distinct media content, said at least one output means for reproducing said media content, said at least one micro-controller, and said at least one source of electrical energy are arranged in recesses or depressions of a solid box (24) fit within said housing (11).

17. The device of claim 16, wherein said box is made of a lightweight plastic material, preferably from polystyrene.
